(19) United States
(12) Patent Application Publication
(10) Pub. No.: US 2006/0197741 A1
(43) Pub. Date: Sep. 7, 2006

(54) Haptic feedback device

(76) Inventor: Christopher Stephen Andrew Biggadike, Cheltenham (GB)

Correspondence Address: Eric D. Cohen, 120 South Riverside Plaza, 22nd Floor, Chicago, IL, 60606-3945, US

(21) Appl. No.: 11/351,741

(22) Filed: Feb. 10, 2006

(30) Foreign Application Priority Data
Mar. 3, 2005 (GB) 0504484.7

(51) Int. Cl. G09G 5/00

(52) U.S. Cl. 345/156

(57) ABSTRACT

A haptic feedback device is described for providing feedback to a user. The device includes a motor, an output element and a pair of magneto-rheological clutches for selectively coupling the motor with the output element. The pair of clutches are configured to drive the coupled element in opposite directions. The device may be provided in a steering wheel or similar.

### FIELD OF THE INVENTION

The present invention relates to a haptic feedback device.

### BACKGROUND OF THE INVENTION

A haptic feedback device is described in U.S. Pat. No. 6,655,490. The device is provided as part of a vehicle steer-by-wire system, and generates steering feedback to the driver of the vehicle. In one variation, steering feedback is provided by an electric motor. In another variation, feedback is provided by a magneto-rheological (“MR”) device.

The use of a switched electric motor introduces the problem of motor inertia. That is, the inertia of the motor makes it difficult to switch quickly, and difficult to make small incremental movements.

MR devices operate by varying the intensity of a magnetic field across a MR fluid and hence do not suffer from the problem of motor inertia. However, MR devices have traditionally only been used in damping applications—that is, providing a resistive damping force.

### SUMMARY OF THE INVENTION

A first aspect of the present invention provides a haptic feedback device including a motor; an output element; and a pair of magneto-rheological clutches for selectively coupling the motor with the output element, wherein the pair of clutches are configured to drive the output element in opposite directions.

The invention provides a number of advantages compared with U.S. Pat. No. 6,655,490. Firstly, the use of a motor enables the device to actively drive the output member, in contrast to the MR device in U.S. Pat. No. 6,655,490 which only provides resistive forces. This enables different types of feedback to be provided. Secondly, the use of a pair of oppositely configured clutches enables the device to vary the direction and quantity of haptic feedback quickly, and also enables a variety of different movements to be generated, such as flutter, rumble or other vibrational movements.

Typically, a brake is also provided for selectively applying a braking force to the output element. The brake may be a conventional contact brake, but more preferably is a magneto-rheological brake.

A second aspect of the present invention provides a haptic feedback device including a motor; an output element; a magneto-rheological clutch for selectively coupling the motor with the output element; and a brake for selectively applying a braking force to the output element. The brake may be a conventional contact brake, but more preferably is a magneto-rheological brake.

In common with the first aspect of the invention, the clutch enables the device to actively drive the output member, in contrast to the MR device in U.S. Pat. No. 6,655,490.

The following comments apply to both aspects of the invention.

The output element may be a user-contact element which contacts a user to provide the haptic feedback. Typically, although not exclusively, the user-contact element will be a user input device such as a steering wheel, joystick, computer mouse, tiller, or yolk. Alternatively, the device may be a module which can be retro-fitted to an existing user-contact element. In this case, the output element is a linking element which can be coupled during retro-fitting to the user-contact element.

The device may be used in any suitable application in which a haptic sensation is to be provided to a user. For example the device may be used in a steer-by-wire feedback system for a wheeled or tracked vehicle, or in a driving simulator or other computer game application.

### BRIEF DESCRIPTION OF THE DRAWINGS

Various embodiments of the present invention will now be described with reference to the accompanying drawings, in which:

FIG. 1 is a cross-sectional view of a haptic feedback device according to the present invention;

FIG. 2 is a schematic diagram of a wheeled vehicle steer-by-wire system including the device of FIG. 1;

FIG. 3 is a schematic diagram of a tracked vehicle steer-by-wire system incorporating the device of FIG. 1;

FIG. 4 is a perspective view of a joystick system incorporating a pair of haptic feedback devices according to the present invention; and

FIG. 5 is a view of a joystick system with an alternative drive-link arrangement.

### DETAILED DESCRIPTION OF EMBODIMENT(S)

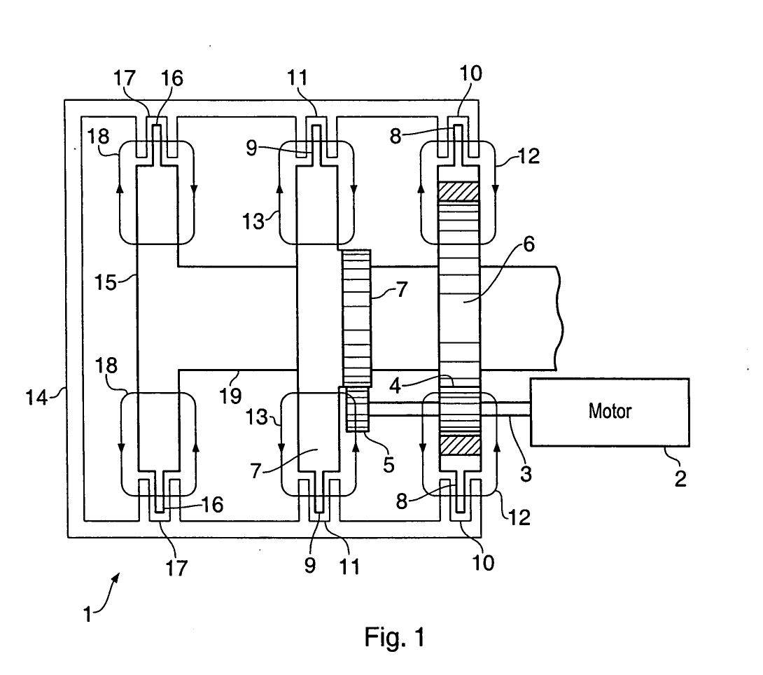

Referring to FIG. 1, a haptic feedback device 1 includes a motor 2 with a drive shaft 3 which rotates at a constant speed and direction. The drive shaft 3 carries first and second spur gears 4, 5. The first gear 4 drives the teeth on the inside of a ring gear 6. The second gear 5 drives the teeth on the outside of a spur gear 7. Thus, the motor 2 constantly drives the ring gear 6 in one direction, and the spur gear 7 in the opposite direction. The gears 6, 7 are configured to run at the same rotational speed.

An output element 14 has three pairs of annular flanges which each define respective slots 10, 11, 17. The gears 6, 7 have annular flanges 8, 9 which are each received in a respective one of the slots 10, 11. The slots 10, 11, 17 contain a magneto-rheological fluid such as Lord MRF-132AD. The fluid just fills the slots 10, 11, 17 which are about 1.7 mm wide and so very little fluid is required. Seals (not shown) are provided. The seals can be either dynamic (rotary) rubber seals suitable for use with synthetic oil, or a permanent magnet can create a seal by solidifying the fluid at the junction. A rubber seal is the more normal solution.

Suitable means (not shown) is provided to generate a controlled magnetic field 12, 13 passing through the flanges 8, 9 and slots 10, 11. Varying the strength of the magnetic field varies the viscosity of the magneto-rheological fluid. Thus, by varying the strength of the magnetic fields 12, 13, the degree of coupling (that is, the driving force) between the annular flanges 8, 9 and the output element 14 can be controlled.

A brake disc 15 has an annular flange 16 which is received in the slot 17. The brake disc is carried on a shaft 19 which is held stationary with respect to the output element 14 and drive shaft 13. Suitable means (not shown) is provided to generate a controlled magnetic field 18 passing through the flange 16 and slot 17. Thus by varying the strength of the field 18, the degree of coupling (that is, the braking force) between the flange 16 and the output element 14 can be controlled. Braking forces can be used to provide stiffness of movement, end stops, and locking in place.

By having three (effectively infinitely variable) elements in a steady state system, it is anticipated that the response speed of the device will be far higher than in an equivalent purely motor driven arrangement. MR fluid reacts almost instantly to changes in magnetic field. As the clutch discs are already moving and do not change speed, the acceleration derived by the clutch is proportional to the magnetic field induced.

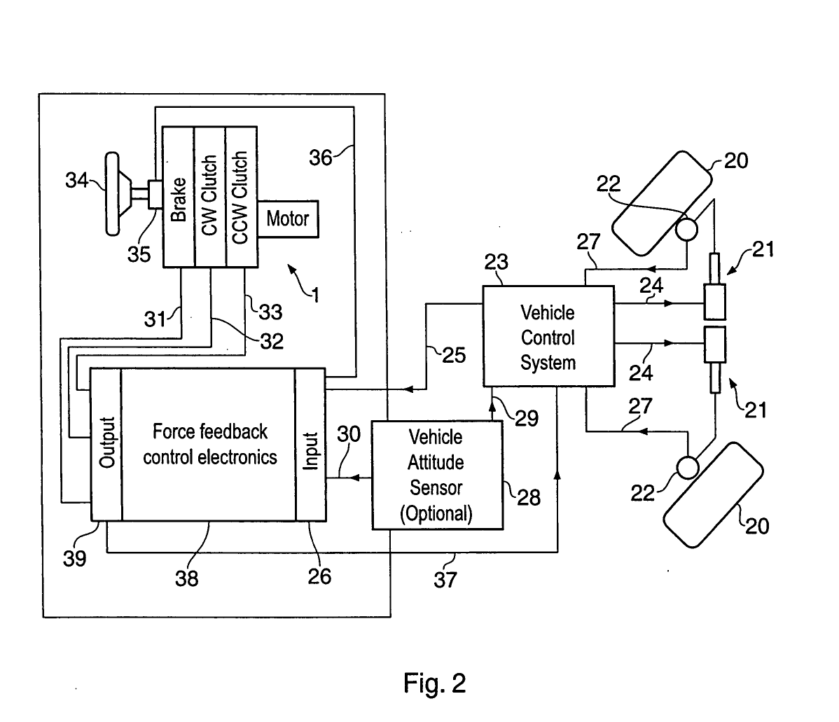

A steering system for a wheeled vehicle is shown in FIG. 2. The system incorporates the device 1 of FIG. 1. A pair of wheels 20 are steered by wheel actuators 21. The angle of the wheels is detected by wheel angle sensors 22. Vehicle control system 23 generates wheel actuator drive data which is output on lines 24 to the wheel actuators 21, and on line 25 to a force feedback control electronics input section 26. The vehicle control system 23 also receives wheel angle data from wheel angle sensors 22 on lines 27. This wheel angle data is also transmitted to the input section 26 on line 25. Optionally, a vehicle attitude sensor 28 may be provided. The sensor provides data which is output to the vehicle control system 23 on output line 29, and to the input section 26 on output line 30.

The force feedback control electronics system 38 has an output section 39 which drives the pair of clutches and the brake via respective control lines 31, 32, 33. The output element 14 (not shown) is coupled to a steering wheel 34. A rotary hall effect sensor (or other rotary position transducer) 35 is also provided to generate rotary position data which is output to the force feedback control electronics input section 26 on output line 36. The force feedback control electronics system 38 also generates vehicle turn request data which is output to the vehicle control system 23 on output line 37.

By using MR fluid as an interface, the feel (haptics) of the feedback system is closer to that experienced during normal driving in comparison to that provided by direct drive from an electric motor.

The principals of operation of the system are as follows:
At all times, the system tries to correlate the control element (steering wheel etc.) angle with the related vehicle state. In a wheeled vehicle, the angle of the wheels relative to the vehicle axis could be used. In a tracked vehicle, a ‘virtual change angle’ can be generated from data received from attitude sensors, slip sensors etc.
When the system is initiated, it moves the control element to a correlated start/datum position from which the user or the system can force a deviation to request a change in vehicle state. An unrequested change in vehicle state would prompt a ‘force feedback’ which is the manifestation of the vehicle state and the control element state being brought into line by the feedback system.
The feedback system needs to be able to apply enough force and braking to resist ‘over-demand’—This is when the user turns the handle at a rate which cannot be matched by the vehicle. This manifests itself as a resistance to turning too quickly.
Other sensed changes in the vehicle state can be conveyed to the user by pre-determined haptic responses in the control element. Thus oscillations, sudden free motion (like steering on ice) bumps and other sensations can be fed to the control handle by the system to indicate the presence of certain sensed vehicle states (slipping, skidding etc.) These pre-determined responses are created artificially from a library of output sequences and are not simply a reflection of raw inputs into the system.
It may be the case that filtering of vehicle inputs is desirable and that much of the ‘noise’ of vehicle system responses are removed from the haptic responses fed to the user.
The essence of the situation is that the user is steering the haptic control part of the system, the vehicle control element is controlling the vehicle and using feedback from the vehicle to ensure that the haptic control that the user sees makes instinctive sense. The actual correlation between the actions the vehicle is being asked to make and the actions the user is requesting via the control element need not be very close. A good example of this is the Eurofighter aircraft which is directly controlled by the flight computer and ‘flown’ by the pilot.
Light forces to replicate side drift can be achieved by activating the appropriate clutch alone but it is envisaged that a more favourable (stable) result will be achieved by applying a degree of stiffness at the same time. The system overall will be more stable if a brake is applied in tandem with one or the other of the clutches.

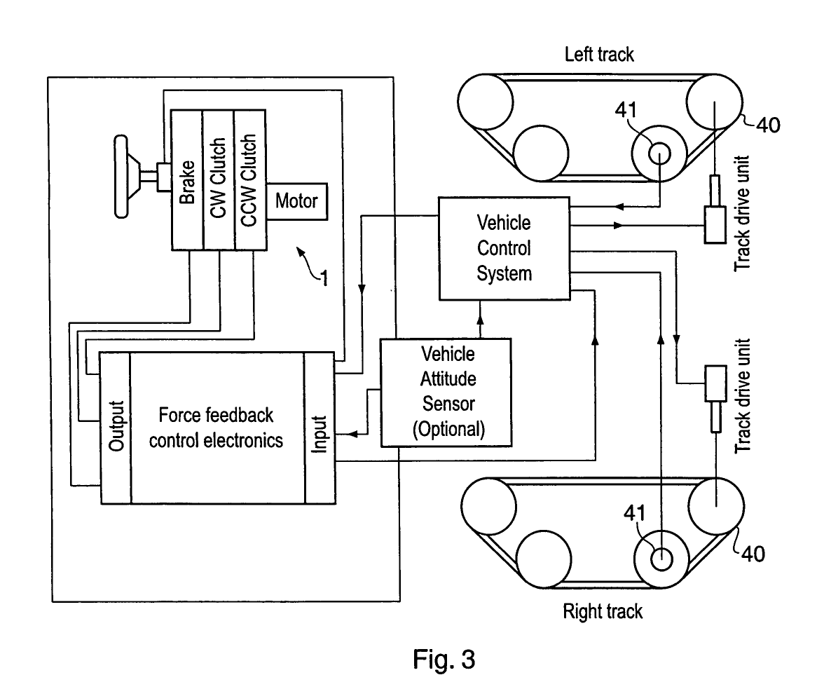

FIG. 3 shows a tracked vehicle incorporating the device 1 of FIG. 1. The wheels 20 of FIG. 2 are replaced by tracks 40, and the wheel angle sensors 22 are replaced by rotary sensors 41. Otherwise, the architecture and principle of operation are similar to FIG. 2.

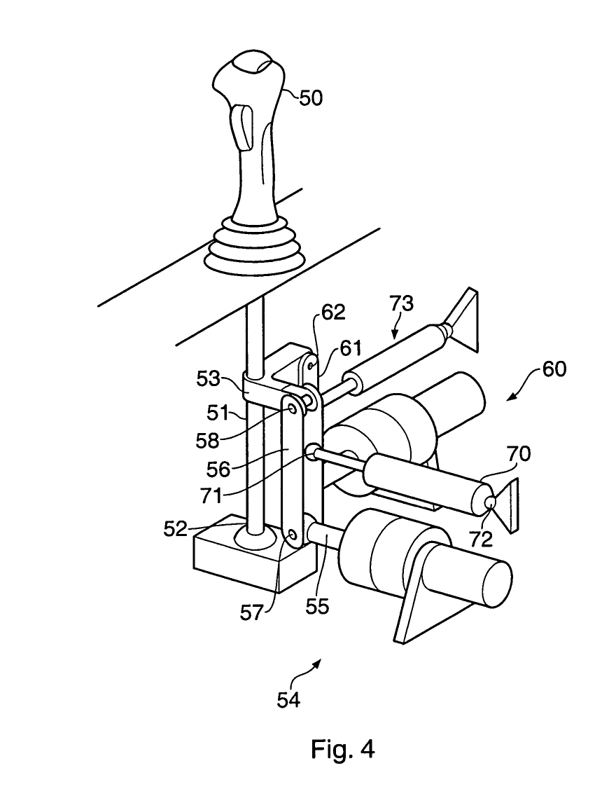

FIG. 4 shows a joystick system incorporating a pair of haptic feedback devices according to the invention. A joystick 50 and shaft 51 are mounted on a ball joint/gimbal 52. An L-shaped bracket 53 is fixed to the shaft 51. A first contra-rotating MR clutch unit 54 has a rotary output shaft 55 mounted to a rotor link 56 via a pin joint 57. The rotor link 56 is mounted at its other end to the L-shaped bracket 53 by a second pin joint 58. The unit 54 is identical in construction to the unit shown in FIG. 1, except that it does not incorporate a brake.

A second contra-rotating MR clutch unit 60 (identical in construction to the unit 54) is arranged at right angles to the unit 60 and is coupled to the L-shaped bracket 53 by a respective rotor link 61 and pin joint 62.

An MR fluid based linear damper/brake 70 is mounted to the rotor link 56 by a ball joint 71. The brake 70 is also mounted to a chassis (not shown) by a ball joint 72 at its other end. A similar brake 73 is provided at right angles to the brake 70, coupled to the other rotor link 61. The linear damper/brake units shown are illustrating a potential improvement to the rotary brakes shown earlier. Either could be used in this application.

Thus it can be seen that the haptic feedback system of FIG. 4 provides movements in two mutually orthogonal directions so as to provide haptic feedback to a user holding the joystick 50.

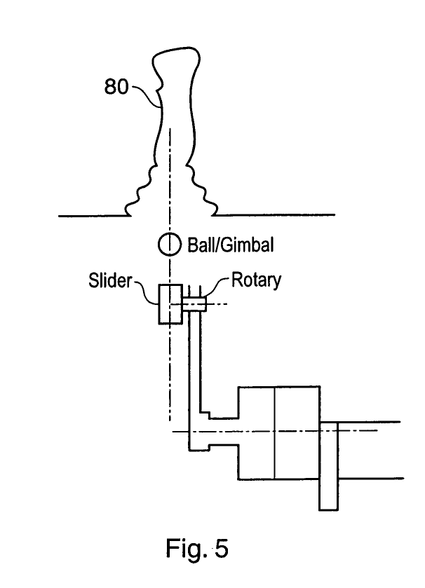

When the available geometry precludes the arrangement shown in FIG. 4, an alternative joystick 80 can be used as shown in FIG. 5. In this example the two opposing haptic feedback units are no longer acting on the pivot point of the grip but are actuating a slider on a rod which hangs below the grip. The small angle of motion required by the grip makes the less linear geometric arrangement still workable. The arm linkage shown in FIG. 5. is very simplified and does not show the number of pivots required to make this arrangement work. The principal would be very similar to that shown in FIG. 4.

Although the invention has been described above with reference to one or more preferred embodiments, it will be appreciated that various changes or modifications may be made without departing from the scope of the invention as defined in the appended claims.

What is claimed is:

1. A haptic feedback device including a motor; an output element; a magneto-rheological clutch for selectively coupling the motor with the output element; and a brake for selectively applying a braking force to the output element.

2. A device according to claim 1 wherein the brake is a magneto-rheological brake.

3. A device according to claim 1 wherein the output element is a user-contact element which contacts a user to provide the haptic feedback.

4. A device according to claim 3 wherein the user-contact element is a user input device.

5. A device according to claim 4 wherein the user input device is a steering wheel, joystick, computer mouse, tiller, or yolk

6. A steering system comprising a steering element, and a device according to claim 1 for providing haptic feedback to the steering element.

7. A steering system according to claim 6 wherein the steering element generates electronic steering data.

8. A joystick comprising a device according to claim 1.

9. A haptic feedback device including a motor; an output element; and a pair of magneto-rheological clutches for selectively coupling the motor with the output element, wherein the pair of clutches are configured to drive the output element in opposite directions.

10. A device according to claim 9 wherein the output element is a user-contact element which contacts a user to provide the haptic feedback.

11. A device according to claim 10 wherein the user-contact element is a user input device.

12. A device according to claim 11 wherein the user input device is a steering wheel, joystick, computer mouse, tiller, or yolk

13. A steering system comprising a steering element, and a device according to claim 9 for providing haptic feedback to the steering element.

14. A steering system according to claim 13 wherein the steering element generates electronic steering data.

15. A joystick comprising a device according to claim 9.
